(19) United States
(12) Patent Application Publication
(10) Pub. No.: US 2026/0266485 A1
(43) Pub. Date: Sep. 10, 2026

(54) VACUUM-ENHANCED MEMBRANE DEHUMIDIFICATION AND HUMIDIFICATION

(71) Applicant: DAIS CORPORATION, Odessa, FL (US)

(72) Inventors: BRIAN JOHNSON, Tampa, FL (US); RASOOL NASR ISFAHANI, Tampa, FL (US)

(21) Appl. No.: 19/165,388

(22) PCT Filed: Mar. 15, 2024
(86) PCT No.: PCT/US2024/020213

§ 371 Date: Sep. 15, 2025

Related U.S. Application Data
(60) Provisional application No. 63/490,389, filed on Mar. 15, 2023.

(51) Int. Cl. F24F 3/147; B01D 53/26; F24F 3/14

(52) U.S. Cl. CPC F24F 3/147; B01D 53/265; B01D 53/268; F24F 2003/1435

(57) ABSTRACT

Systems and methods for vacuum-enhanced membrane dehumidification and humidification are provided. An evacuated region can be established between a first surface of a nonpermeable material and a first surface of a permeable membrane that provides for efficient movement of vapor between the surfaces while limiting the sensible transfer of heat between those surfaces. Decoupling these surfaces makes it possible to maintain a selected temperature at the first surface of the nonpermeable material without substantially altering the sensible temperature of the fluid in contact with the second surface of the permeable membrane.

### CROSS-REFERENCE TO RELATED APPLICATION

This application claims the benefit of U.S. Provisional Application Ser. No. 63/490,389, filed Mar. 15, 2023, the disclosure of which is hereby incorporated by reference in its entirety, including all figures, tables, and drawings.

### BACKGROUND

For many decades, sensible heat transfer has been used to reduce the temperature of a process fluid with multiple constituents so that one of the species reaches saturation and condenses into a liquid (or occasionally freezes directly into a solid) that can be physically separated from the process fluid. In the most common example of this process, a portion of the water vapor present in a humid air stream condenses to a liquid and is removed by gravity, which is a process that can be used to regulate the moisture content of the air.

### BRIEF SUMMARY

Embodiments of the subject invention provide novel and advantageous systems and methods for vacuum-enhanced membrane dehumidification and humidification. The concept of conditioning a process fluid through the movement of heat and/or mass through selective membranes is extended to provide important advantages to the user. An evacuated region can be established between a first surface of a nonpermeable material and a first surface of a permeable membrane (e.g., a first surface of a permeable membrane that faces the first surface of the nonpermeable membrane) that provides for efficient movement of vapor between the surfaces while limiting the sensible transfer of heat between those surfaces. Decoupling these surfaces makes it possible to maintain a selected temperature at the first surface of the nonpermeable material without substantially altering the sensible temperature of the fluid in contact with the second surface of the permeable membrane.

In an embodiment, a system for changing a humidity level of a process air (i.e., humidification of the process air and/or dehumidification of the process air) can comprise: a permeable membrane having a first surface and a second surface opposite from the first surface, wherein the second surface is configured to be in direct physical contact with the process air as the process air travels through the system; a condenser comprising a nonpermeable material and having a first surface facing the permeable membrane; and an evacuated volume between the first surface of the condenser and the first surface of the permeable membrane. The membrane can be selectively permeable (e.g., permeable to water and/or water vapor but not to (some or all) other entities). The first surface of the condenser and the evacuated volume can be disposed in a portion of the system that is sealed (e.g., vacuum sealed) from an outside and only allows fluid to enter and/or exit via the permeable membrane. The condenser can comprise cooling tubes configured to have chilled fluid passed therethrough to thereby cool the evacuated volume, and the cooling tubes can comprise the nonpermeable material. The permeable membrane can comprise vapor channels configured to have vapor molecules of the process air flow therethrough and into the evacuated volume. The permeable membrane can comprise a styrenic block copolymer with partial sulfonation, and the styrenic block copolymer can comprise hydrophilic regions within a solid polymer layer thereof. The system can further comprise a chilled liquid in direct physical contact with the first surface of the permeable membrane (during operation of the system), and the chilled liquid can have a temperature lower than a dewpoint of the process air. The system can be configured to switch between a dehumidification mode configured to decrease the humidity level of the process air and a humidification mode configured to increase the humidity level of the process air. The system can be configured such that the condenser can be switched to operate such that vapor is generated in the evacuated volume at a vapor pressure higher than that of the process air, thereby resulting in humidification of the process air as the process air travels through the system. The system can further comprise a storage chamber configured to collect condensation that forms on the first surface of the condenser. The system is configured such that condensation in the storage chamber is provided to the first surface of the condenser in a humidification mode of the system. The system can be configured to cool the process air before the humidity level of the process air is decreased. The system can be configured such that condensation occurs within the system before the humidity level of the process air is decreased. The permeable membrane can be a first stage of dehumidification for the process air, and the system can comprise a second stage of dehumidification for the process air after the process air exits the first stage of dehumidification. The system can be configured to collect condensation from the first stage of dehumidification and the second stage of dehumidification in a single common collector. The system can be configured to provide condensation from the first stage of dehumidification and the second stage of dehumidification to a separate humidifier in operable communication with the system (or a humidifier that is part of the system). A pressure of the evacuated volume during operation can be lower than a vapor pressure of the process air when the system operates in a dehumidification mode. The system can be configured to collect condensation that forms on the first surface of the condenser and use the condensation as a fluid within the condenser. The system can further comprise a film of a desiccant solution disposed on the first surface of the condenser. The first surface of the condenser can be completely covered with the film of the desiccant solution.

In another embodiment, a method for changing a humidity level of a process air (i.e., humidification of the process air and/or dehumidification of the process air) can comprise: providing a system as disclosed herein (having any, all, or any combination of the features discussed in the previous paragraph); sending the process air having a first humidity level into an inlet of the system while operating the condenser of the system; and allowing the process air to exit an outlet of the system with second humidify level different from the first humidity level. The method can further comprise providing a chilled liquid in direct physical contact with the first surface of the permeable membrane while the process air is in the system, and the chilled liquid can have a temperature lower than a dewpoint of the process air. The condenser can be operated such that vapor is generated in the evacuated volume at a vapor pressure higher than that of the process air, thereby resulting in humidification of the process air as the process air travels through the system (i.e., a humidification mode of the system). The condenser can be operated such that a pressure of the evacuated volume is lower than a vapor pressure of the process air, thereby resulting in dehumidification of the process air as the process air travels through the system (i.e., a dehumidification mode of the system). The method can further comprise: collecting condensation that forms on the first surface of the condenser in a dehumidification mode of the system; and providing the collected condensation to the first surface of the condenser in a humidification mode of the system. The method can further comprise cooling the process air before the humidity level of the process air is decreased, and/or condensation can occur within the system before the humidity level of the process air is decreased. The method can further comprise providing any portion of (or all) condensation collected within the system to a separate humidifier in operable communication with the system (or a humidifier that is part of the system). The method can further comprise: collecting condensation that forms on the first surface of the condenser; and using the condensation as a fluid within the condenser.

### BRIEF DESCRIPTION OF DRAWINGS

FIG. 1 shows a plot of humidity ratio (in grains per pound (grains/lb)) versus temperature (in degrees Fahrenheit (F)), showing NanoAir™ psychometric states points versus those of conventional heating, ventilation, and air conditioning (HVAC).

FIG. 2 shows a cross-sectional view of a dehumidifier concept, according to an embodiment of the subject invention.

FIG. 3 shows a plot of humidity ratio (in grains/lb) versus temperature (in ° F.), showing reversal of the order of operations in NanoAir™ (i.e., a two-stage operational strategy), according to an embodiment of the subject invention.

FIG. 4 shows a plot of humidity ratio (in grains/lb) versus temperature (in ° F.), showing reversal operation of NanoAir™ with condensation.

FIG. 5 shows a plot of humidity ratio (in grains/lb) versus temperature (in ° F.), showing NanoAir™ dehumidification alone.

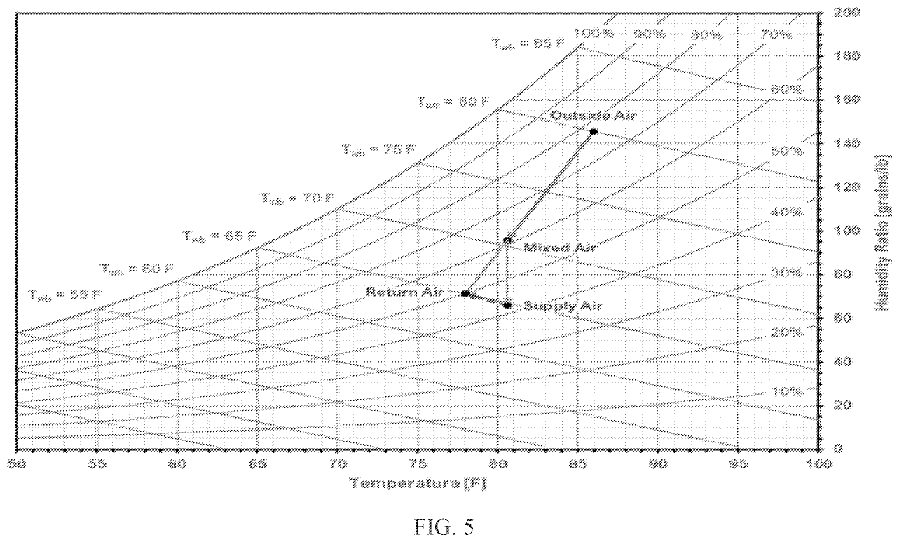

FIG. 6 shows a plot of humidity ratio (in grains per kilogram (grains/kg)) versus dry bulb temperature (in degrees Celsius (° C.)), showing psychometric cycle test data, according to an embodiment of the subject invention.

FIG. 7 shows a schematic view of a system according to an embodiment of the subject invention.

FIG. 8 shows a plot of humidity ratio (in grains/lb) versus temperature (in ° F.), showing a thermodynamic cycle at the Air-conditioning, Heating, and Refrigeration Institute (AHRI) 1060 cooling design condition.

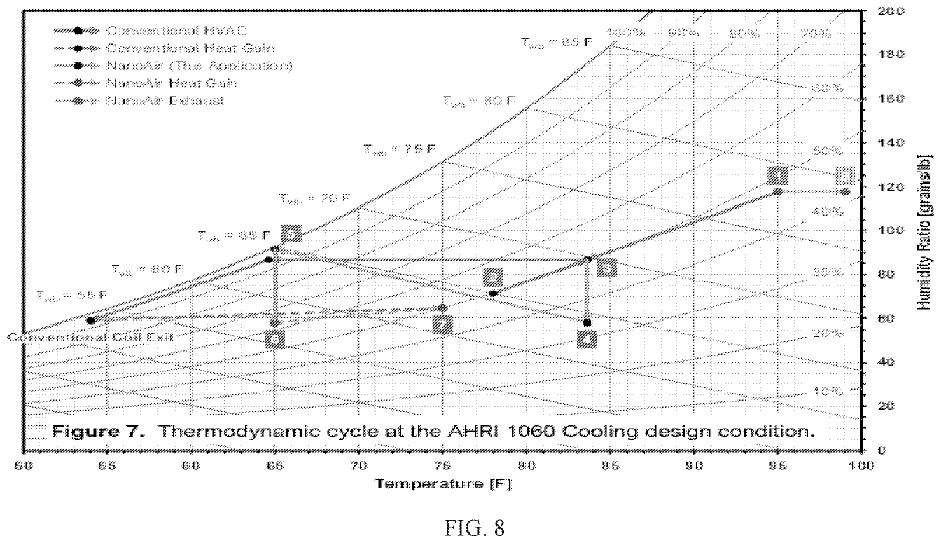

FIG. 9 shows a plot of humidity ratio (in grains/lb) versus temperature (in ° F.), showing a thermodynamic cycle at a maximum dehumidification design condition.

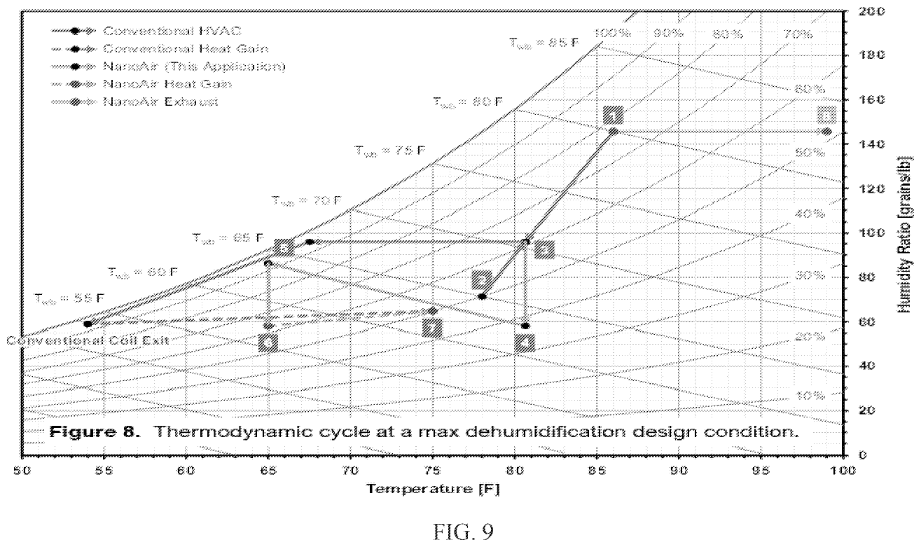

FIG. 10 shows a schematic view of a system according to an embodiment of the subject invention.

FIG. 11 shows a plot of humidity ratio (in grains/lb) versus temperature (in ° F.), showing operation with dry inlet conditions.

FIG. 12 shows a cross-sectional view of a desiccant dehumidifier with vacuum isolation, according to an embodiment of the subject invention.

### DETAILED DESCRIPTION

Embodiments of the subject invention provide novel and advantageous systems and methods for vacuum-enhanced membrane dehumidification and humidification. Various methods of conditioning a process fluid (usually, but not exclusively, air) through the movement of heat and/or mass through selective membranes are disclosed in U.S. Pat. Nos. 8,470,071, 9,283,518 (hereinafter referred to as “the '518 patent”), U.S. Pat. Nos. 10,907,867, 11,331,628, and U.S. Patent Application Publication No. 2018/0320988, all five of which are hereby incorporated by reference herein in their entireties. Embodiments of the subject invention extend these concepts and provide important advantages to the user. A key innovation of embodiments of the subject invention is the establishment of an evacuated region between a first surface of a nonpermeable material and the first surface of a permeable membrane that provides for efficient movement of vapor between the surfaces while limiting the sensible transfer of heat between those surfaces. The membrane can be selectively permeable (e.g., permeable to water and/or water vapor but not to (some or all) other entities). Decoupling these surfaces makes it possible to maintain a selected temperature at the first surface of the nonpermeable material without substantially altering the sensible temperature of the fluid in contact with the second surface of the permeable membrane (i.e., the “process fluid”). When the first surface of the nonpermeable material is below the dewpoint of the process fluid at the second surface of the permeable membrane, the process fluid will be dehumidified by the flow of vapor through the membrane to condense on the nonpermeable material, yet the temperature of the process fluid will not decrease and cause condensation of vapors in the fluid channels. If a fluid resides in the evacuated space between the first surfaces and is maintained at a sufficient temperature above the dewpoint of the fluid at a second surface of the permeable membrane (different from the first surface of the permeable membrane (e.g., opposite from the first surface of the permeable membrane)), vapor will be driven from the evacuated space through the membrane to increase the vapor pressure of the process fluid without substantially affecting its temperature.

The text and/or figures may refer to water, air, steam, and other specific substances. It should be generally understood that other chemical species can fill the same roles within embodiments of the subject invention and that the reference in question is not intended to limit the applicability of the embodiments of the subject invention. Similarly, alternative methods of heating and cooling (such as convective heat exchange, radiative heat exchange, Joule heating, thermoelectric heating, etc.) are envisioned to be within the scope of this disclosure and embodiments of the subject invention even in the absence of specific mention thereof. Many examples may also refer to the vapor being at an absolute pressure lower than the prevailing atmospheric pressure, but there are also examples where the vapor pressure may be higher than atmospheric pressure, and these are also envisioned to be within the scope of this disclosure and embodiments of the subject invention.

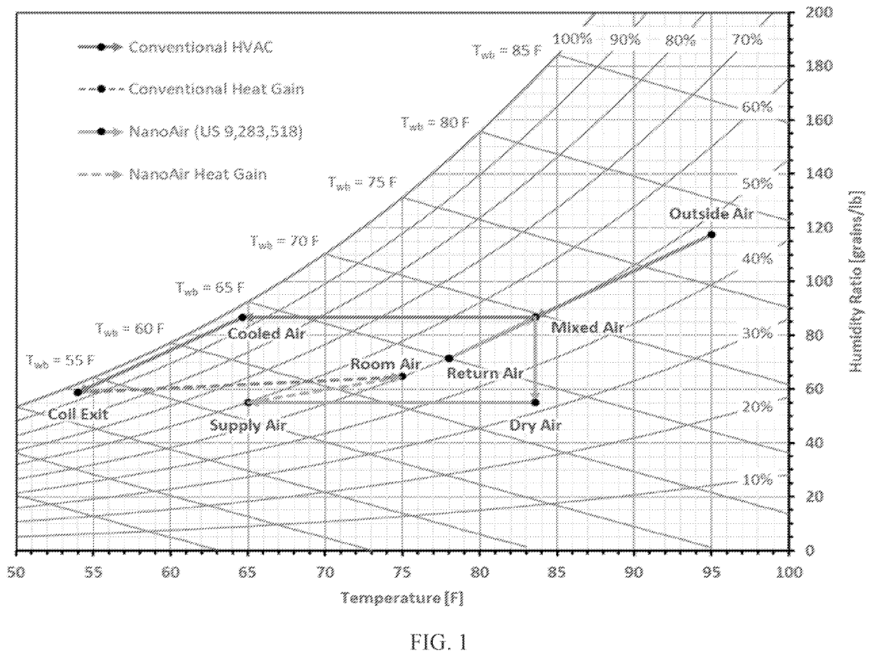

Dais Corporation of Odessa, Florida has previously developed and patented the Aqualyte™ membrane, a thin material that rapidly transports small, polar molecules like water and ethanol while effectively blocking the movement of nonpolar gas molecules like oxygen and nitrogen (see also the '518 patent). The '518 patent showed how a vacuum can be established on one side of the Aqualyte™ material while the water vapor in the process fluid passing on the opposite side of the membrane interacts with the vapor pressure on the vacuum side of the material, allowing the creation of a membrane dehumidifier that draws water vapor out of the process fluid or a membrane humidifier that supplies additional water vapor to the process fluid. The '518 patent further demonstrates how the membrane dehumidifier component can be used to isothermally reduce the moisture content of the process fluid without saturating and condensing the vapor, enabling a fundamentally new heating, ventilation, and air conditioning (HVAC) cooling cycle where the process air is first dried and then cooled sensibly without creating a liquid condensate, as shown in FIG. 1. A conventional HVAC process is illustrated for comparison, showing how sensible heat transfer on the surface of a cooling coil first cools the air to saturation before removing humidity as liquid condensate.

The NanoAir™ process described in the '518 patent has several advantages over conventional HVAC. First, the dehumidification and cooling processes are independent and are typically carried out by separate components that can be operated independently from each other. This allows continued dehumidification even after the temperature setpoint for the building has been reached. Continued operation of a conventional system would require additional reheat in the system to prevent the space dropping below the temperature setpoint in the quest for additional dehumidification. Second, independent operation allows infinite variability in the sensible heat ratio (SHR) of the unit. In conventional HVAC systems there are limitations on the ability of the design to adapt the ratio of sensible heat transfer to latent heat transfer, and a mismatch between the SHR of the unit and the operating conditions causes frequent cycling and a tendency for the room relative humidity (RH) to remain uncomfortably high even if the temperature is at the desired setpoint. Third, NanoAir™ operates a higher percentage of the time at part-load conditions and still maintain occupant comfort, which helps to right-size the system instead of being oversized and only operating for a limited duty cycle. Fourth, as disclosed in the '518 patent, it is possible to create a NanoAir™ cycle without using conventional refrigerants that impact the global climate crisis. To clarify, the above benefits can be realized in a system that combines any form of isothermal dehumidification like the one described with any form of sensible cooling. This allows a system to match a membrane dehumidifier with a conventional cooling coil and still see independent operation of the dehumidification and cooling effects. In this case, the conventional cooling coil is not expected to see condensing conditions, which can actually be used to optimize the system vs. traditional operation.

The rate of membrane dehumidification as previously described is dependent on two main factors: the driving force between the humid airstream and the conditions drawing water through the membrane, which is described in the '518 patent as a vapor pressure differential between the two surfaces of the material; and the overall resistance to transfer of the dehumidification system, which can typically be expressed in terms of the convective resistances governing the movement of water molecules through the process fluid to reach the membrane or depart from the membrane and the conductive resistance of the membrane itself.

In a pervaporation membrane transferring water molecules between the two surfaces, the conductive resistance of the material is highly dependent on its hydration state. The presence of water absorbed into the membrane is key to maintaining an effective linkage between the two surfaces, and while the material chemistry and structure can be optimized to maintain performance in most conditions, there is a general trend towards increased conductive resistance of the membrane as its water content decreases. With most candidate materials, there is a strong correlation between the water content of the material and the relative humidity of the fluids in contact with it. As the RH decreases, more water tends to be drawn out of the material and it equilibrates at a lower water content. Said lower water content tends to decrease connectivity between the surfaces and therefore increases conductive resistance to mass transfer.

The implications of this effect can be seen in FIG. 1, where the initial dehumidification step decreases the RH of the airstream passing over the membrane dehumidifier. This causes the exit portions of the device to be less efficient than the inlet portions, and as the RH targeted decreases the amount of membrane needed to achieve those exit conditions increases in a highly nonlinear fashion. This acts to limit the practical amount of dehumidification possible under these conditions.

The membrane dehumidifier disclosed in the '518 patent is used as an explanatory device. This is not intended to be limiting, as there may be other methods of isothermal dehumidification possible, and they may have some of the same characteristics in terms of driving forces and resistances. In the same vein, the molecules being transferred may be something other than water (ethanol is an example of a species able to transit some of the pervaporation membranes described), and the process fluid may be something other than traditional air (e.g. flue gases or a carbon dioxide stream).

Embodiments of the subject invention can: incorporate permeable membrane into condensing surfaces; vacuum insulate membrane surfaces from cooling surfaces; reverse the flow of vapor to humidify the process fluid; utilize cyclic movement of condensable fluid; invert the dehumidification and chilling processes; allow condensation before dehumidification; post-treat evaporatively cooled air; operate with chilled condenser instead of vapor compressor; recover heat to drive evaporative cooling; maintain a vacuum in dehumidifiers and other components; reduce water consumption in dry conditions; minimize sensible heat gain with desiccant solutions; and/or be used for distillation processes.

Innovative Feature: Incorporate Permeable Membrane into Condensing Surfaces

Maintaining a vapor pressure differential to drive membrane dehumidification requires the removal of water vapor from the first surface of the membrane so that it stays at a lower vapor pressure than that found in the fluid on the second surface of the membrane. This vapor can be removed while still in vapor form or condensed into a liquid that occupies much less volume and can then be removed. Examples of removal in vapor form include the use of a vacuum pump to increase the pressure so the vapor can be expelled directly and the use of a vapor compressor to move the vapor to a subsequent component where condensation or a similar mechanism can remove the vapor.

Embodiments of the subject invention can utilize a chilled surface to cause condensation of the vapor being pulled through the permeable membrane without needing an additional compression step or removal at atmospheric pressure. If a chilled liquid with a temperature lower than the dewpoint of the process fluid is presented to the first side of the permeable membrane, it will cause vapor molecules in the process fluid to transfer through the membrane and condense into the chilled fluid. This reduces the vapor pressure of the process fluid even before the process fluid approaches its saturation temperature, but sensible heat transfer between the membrane surface and the process fluid will cause the process fluid to saturate unless there is significant insulating capability to the permeable membrane that keeps the process fluid above its dewpoint.

If the process fluid reaches saturation temperature as it flows over the permeable membrane, condensation will begin to occur on the second surface of the membrane. The presence of liquid on the second surface of the membrane will decrease the ability of the membrane to transfer water, as the liquid tends to cool towards the same temperature as the cooling liquid on the first surface of the membrane. The only temperature differential is maintained by the insulating properties of the membrane, and these tend to be minimal in the types of thin materials that allow a substantial flux of water molecules to transfer. As temperatures equilibrate between the two liquid layers, transfer drops to very low levels.

Innovative Feature: Vacuum Insulate Membrane Surfaces from Cooling Surfaces

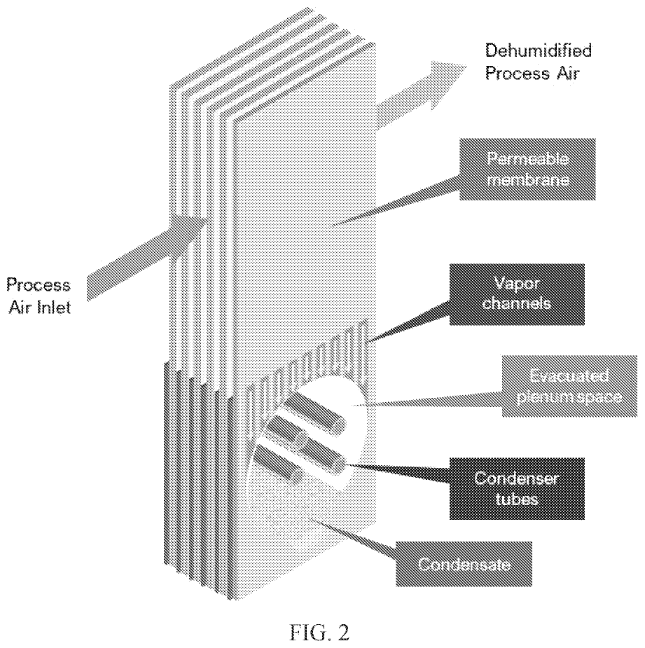

The NanoAir™ cycle described in FIG. 1 is attractive to an engineer because it enables separate sensible and latent cooling and control while eliminating condensation on the surfaces of the separate heat exchanger reducing the process fluid temperature. A membrane dehumidifier with poor insulating properties does not maintain that separation, as the process fluid is drawn towards the cooling fluid temperature. FIG. 2 shows a cross-sectional view of a dehumidifier, according to an embodiment of the subject invention. Referring to FIG. 2, an evacuated gap between the process fluid and the cooling fluid insulates the membrane surface and provides space to handle the condensation separately from the cooling fluid. Vapor molecules stay in the vapor phase as they transit the permeable membrane and the insulating gap until they begin to condense against the nonpermeable surface separating the vacuum gap from the cooling mechanism (typically but not exclusively a fluid chilled by another system).

The membrane (e.g., Aqualyte™ membrane of the type disclosed in the '518 patent) ensures that there is minimal crossover of noncondensable substances that might leak through a porous membrane. This allows easy maintenance of the evacuated space with minimal cycling of the vapor pump that maintains internal pressures; for example, if nitrogen and oxygen molecules are entering the evacuated space, the pressure rises and those stray molecules begin to interfere with the movement of water vapor to the condenser surface. As a material, Aqualyte™ has very low transmission rates for nitrogen and oxygen molecules, even while it is moving water molecules rapidly between its surfaces.

With a strong vacuum in the space between the membrane and the cooling tube, convective and conductive losses are minimized. The membrane surface temperature is primarily influenced by the temperature of the process fluid, and the absence of significant heat transfer from the membrane surfaces minimizes changes in process fluid temperature through the dehumidifier. Very importantly, the process fluid is not unduly saturated because of decreasing temperatures and the tendency to accumulate liquid condensate on the second surface of the membrane is defeated. Instead, condensate forms on the surfaces of the cooling system and is collected at a distance from the membranes to make space for more vapor molecules to be brought through the membrane.

This advantageous and innovative design incorporates the benefits of both shell-and-tube and plate-and-frame designs. The plate-and-frame design provides a compact and efficient solution, enabling a high density of membrane surface area. The shell-and-tube design, on the other hand, permits operation of chilled water at elevated pressures, without compromising the integrity of the seals within the device.

### Innovative Feature: Reverse the Flow of Vapor to Humidify the Process Fluid

By intentionally introducing vapor at a higher pressure than the vapor pressure of the process fluid, the device can be used to humidify or otherwise add vapor molecules to the process fluid. This alternate mode of operation does not require significant reconfiguration of the system; instead, the condensable fluid is maintained at a temperature that generates vapor in the evacuated region of the system with a higher pressure than the vapor pressure of the condensable fluid in the airstream at the second surface of the membrane. Under these conditions, the net mass flow through the membrane acts to increase the vapor pressure of the airstream, turning the device into a humidifier. In an application where a cooling fluid is used to remove heat from the second surface of the heat transfer material in dehumidification mode, the device can be switched into humidification mode by spraying or dripping the liquid water onto the first surface of the heat transfer material and then heating the fluid against the second surface to increase the partial pressure of the water in the evacuated space and drive the humidification process at the membrane.

### Innovative Feature: Cyclic Movement of Condensable Fluid

Because the components of embodiments of the subject invention (as disclosed herein) have a dual nature, they can be cycled between humidification and dehumidification. A device can induce condensation with a cooled surface, collect the condensation in a storage chamber, and then switch to humidification mode as described above to circulate the condensate over a heated surface, causing it to evaporate and creating a high enough vapor pressure to drive the vapor through the membrane and into the airstream.

### Innovative Feature: Invert the Dehumidification and Chilling Processes

The NanoAir™ cycle described in FIG. 1 is attractive to an engineer because it effectively eliminates the possibility of external condensation of water on the heat transfer surfaces and eliminates the need for a drain system in the process air stream. However, the decrease in relative humidity increases the amount of membrane surface area needed to dehumidify the air. Embodiments of the subject invention can reverse the order of components in the NanoAir™ system so that cooling happens before dehumidification. The cooling step increases the relative humidity of the air before it is dehumidified, helping to maintain hydration in the pervaporation membrane and reducing the surface area required.

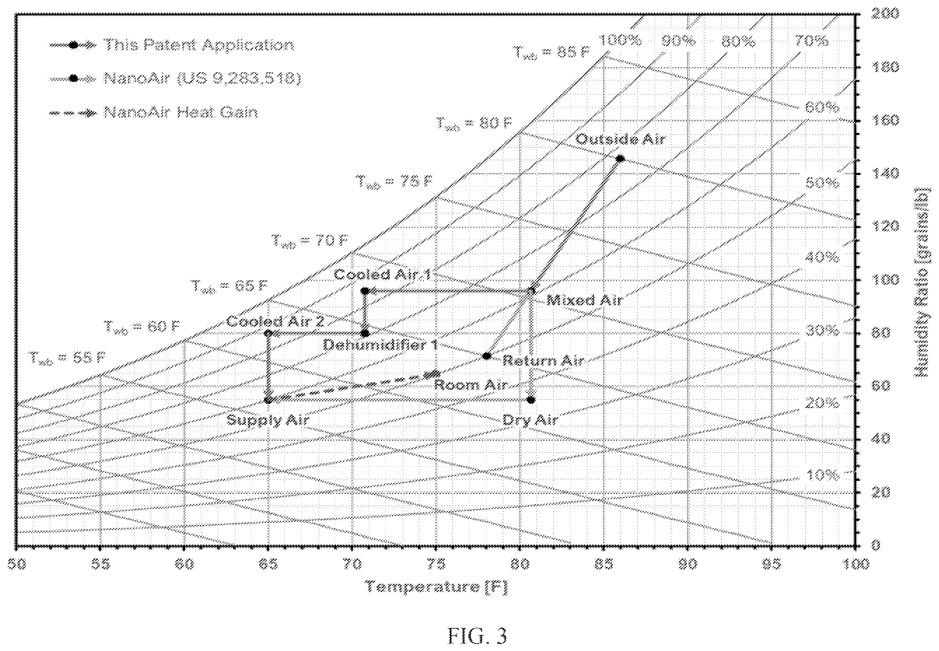

One consideration is that of control. Cooling before dehumidifying introduces the possibility of saturating the air and beginning to condense water on the external surfaces of the devices and on the membrane used for dehumidification. One way to prevent or inhibit this from happening is to break the process into multiple stages and alternate the cooling and dehumidification to maintain the membrane in a desired hydration state without saturating the air. An example of this approach is shown in FIG. 3, which contrasts this approach with the previously disclosed approach placing the dehumidifier first.

The cooling coils can be sized or operated in such a manner to keep the maximum RH of the airstream in a range of from 80% to 90% (or from about 80% to about 90%), where membrane resistance is low but saturation is not occurring on the surface. Monitoring of the air stream RH can be useful in controlling the air and refrigerant flow rates to ensure this optimum operational state.

### Innovative Feature: Allow Condensation Before Dehumidification

If an engineer can allow for the possibility of external condensation of water on the heat transfer surfaces, it becomes possible to pair a membrane dehumidifier with a conventional cooling coil and still gain many of the benefits of NanoAir™ by placing the conventional cooling coil before the isothermal dehumidification. If the cooling step saturates the air, condensation and removal of moisture will occur, but the cooling process is stopped before reaching the temperature needed to remove all of the undesirable moisture from the air. Instead, an isothermal dehumidification step follows, but the efficiency of this step is maximized by operating with the highest possible relative humidity during dehumidification to maintain hydration and reduce the surface area required.

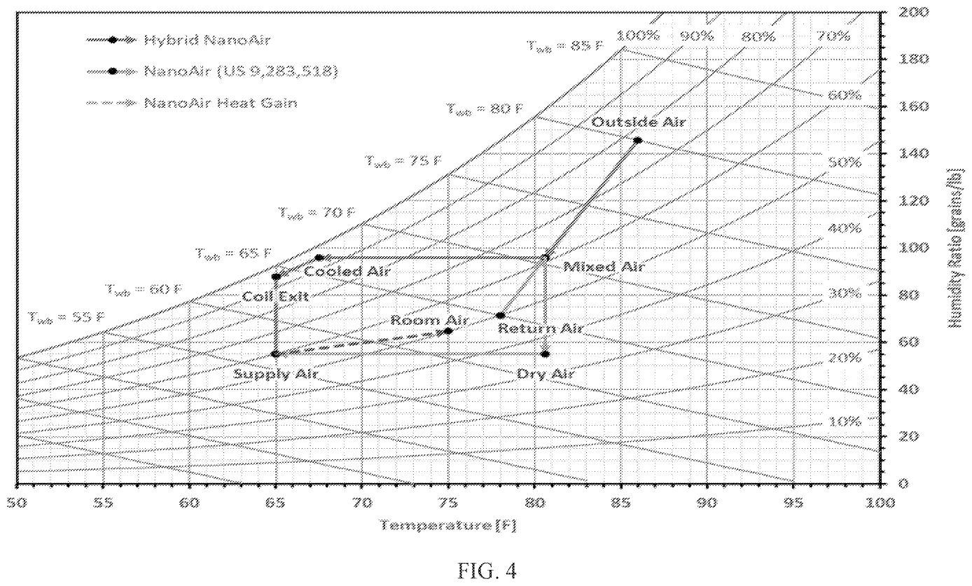

This approach simplifies control and sizing of the components, as there is no need to break the process into multiple stages to prevent saturation of the air. An example of this approach is shown in FIG. 4, which contrasts this approach with the previously disclosed approach placing the dehumidifier first.

If cooling is not provided to the conventional coil, the membrane dehumidifier can still be operated independently to provide dehumidification without cooling for better moisture control. Further, this dehumidification-only mode can be used in any of the NanoAir™ scenarios disclosed herein.

### Innovative Feature: Post-Treat Evaporatively Cooled Air

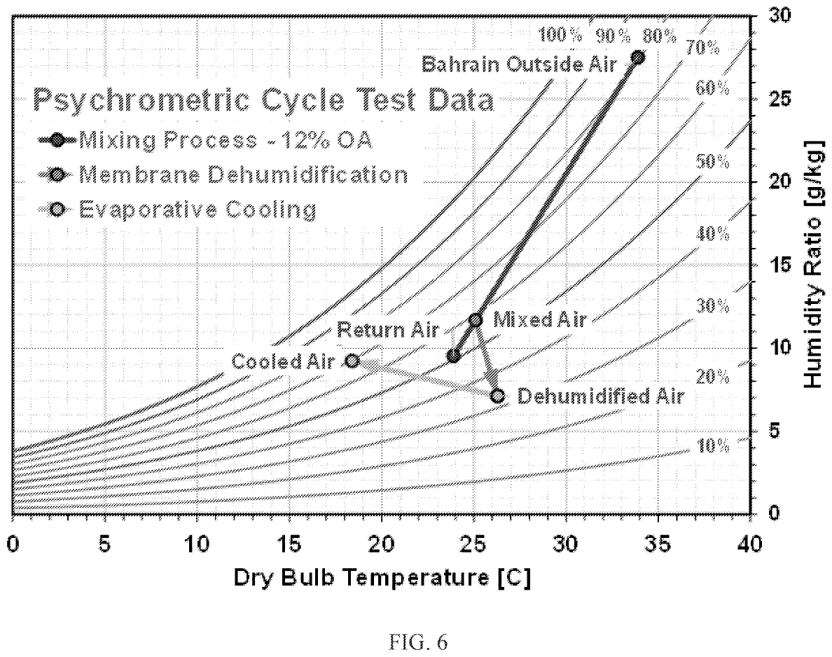

Membrane dehumidification under the NanoAir™ system allows for isothermal reduction in the moisture content of air passing over a membrane surface. The inventors of the subject invention have demonstrated that it is possible to dehumidify a mixture of return air and outside air to a low enough humidity that adiabatic evaporative cooling becomes practical, as shown in FIG. 6.

The outside air in this test was some of the most extremely humid air found in nature, but the percentage of outside air introduced to the return air was low enough that the resulting mixed air was representative of what could be expected in typical usage with more moderate outdoor air and a higher ventilation rate. After membrane dehumidification, the air was reduced to almost 30% RH. Heat exchange with the test lab increased the air temperature slightly, but it was still possible to use evaporative cooling to reduce the temperature in a meaningful way without reaching saturation.

A shortcoming of this approach is that the evaporative cooling process can sometimes result in the introduction of air that is near saturation with water vapor into the occupied space. This can reduce the ability to control space humidity and result in air that is often described as “clammy” because of its high RH. Embodiments of the subject invention can include any or all of the following innovations to improve this system.

1. Add a second stage of membrane dehumidification to reduce the moisture content of the air exiting the evaporative cooling stage before it is reintroduced to the occupied space.

2. Use a common plenum to direct the water vapor removed from both membrane dehumidification stages to the input of a single vapor compressor, minimizing the hardware needed by the system.

3 Return condensate from the membrane dehumidification process to a membrane humidification device operating in between the two stages of dehumidification. This allows the system to reuse condensate without returning it to atmospheric pressure. The higher temperature of the condensate increases the enthalpy of the air exiting the humidifier by 1%-2% (or less), a negligible effect.

4. Because the second dehumidifier is operating from the same draw pressure as the first dehumidifier, it will tend to produce air that exits at a similar vapor pressure. This has the effect of removing the moisture added to the air by the humidifier and returning it to the condensate system for re-use. Because there is no net use of water by the cooling process, the condensate produced by the first stage of dehumidification is in excess of the needs of the system. A collection system can be added to the condensate system that collects low pressure liquid water that is in excess of the amount operating the evaporative cooling process, segregates the excess, and then returns it to atmospheric pressure. This water is extremely pure, having been removed from the air and collected inside a vacuum system operating at a small percentage of atmospheric pressure, making it suitable for potable use without further treatment (unless residual disinfection is desired to allow long term storage).

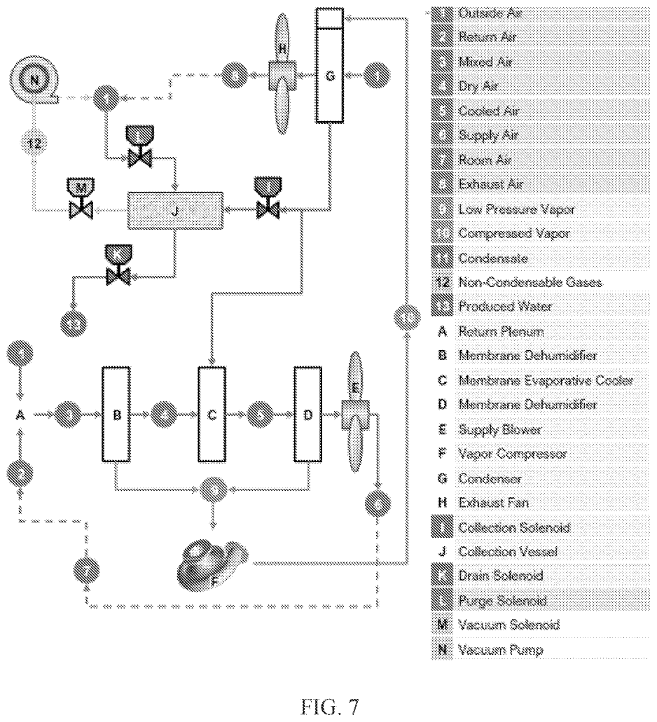

FIG. 7 shows a schematic view of a system, according to an embodiment of the subject invention. Referring to FIG. 7, while the condensate collection system (I through M) is shown upstream of the membrane evaporative cooler (C) in this embodiment, it is also possible to place this system downstream of C or incorporate the collection system into the design of C itself.

A key assumption is that the vapor compressor will apply a common vapor pressure against both membrane dehumidifiers (B) and (D). It is believed they will draw the passing air stream to a similar exit vapor pressure. In this case, that is expected to result in an exit condition of 58 (or about 58) grains of moisture per pound of air for both air streams. This ensures that the membrane evaporative cooler (C) and the second membrane dehumidifier (D) will add and subtract the same amount of moisture from the process air. Because the membrane evaporative cooler is fully supplied with this moisture, the condensate from the vapor generated by the first dehumidifier (B) will be in excess of the system needs and can be captured and removed from the system as clean, potable water.

This assumption is not meant to be limiting. It is possible to configure the system so that the two membrane dehumidifiers are operated independently by two vapor compressors, which would allow more independent control. It is also possible that the vapor output from the two compressors could be directed to two different destinations instead of a common condenser. It is also possible to have a single destination, but to make that destination a membrane humidifier instead of a condenser (G). As disclosed in the '518 patent, a membrane humidifier (sometimes referred to as an “expirator”) can allow water vapor to be exhausted to the outside airstream as long as the compressor raised the pressure of that vapor above the vapor pressure of the outside air. This would require that the membrane humidifier shown in FIG. 7 receive liquid water from an external source. It is further possible that a system with two destinations for the compressed vapor could send some vapor to a condenser that resupplies the membrane evaporative cooler with condensate and the remainder of the vapor to a membrane humidifier (not shown in FIG. 7) to be exhausted from the system.

Another design choice shown in the embodiment of FIG. 7 is the use of a variable speed fan on the outside exhaust air. Because the compressor is producing water vapor that condenses at a consistent saturation temperature (104° F. in this example), the fan can be slowed down when the outside air is cooler than the design conditions, allowing the air to heat up to a consistent approach temperature while minimizing fan energy. This is not meant to be a limiting choice; it is quite possible to construct the system with a fixed airflow and allow the saturation temperature to vary or to use a different method of rejecting energy outside of the conditioned space so that the water vapor condenses, and such designs are explicitly claimed as part of this application.

A major enabling technology for this cycle is the use of membrane humidification driven by the evaporation of liquid water into the air stream. This depends on a material that allows rapid passage of water molecules while keeping nitrogen, oxygen, and other components of the airstream from flowing the opposite direction and compromising the evacuated subsystem connecting the various components. While it is possible to return the condensed water that feeds the humidifier to atmospheric pressure to feed a traditional evaporative cooler (and such approaches are explicitly disclosed herein as features of embodiments of the subject invention), the process requires either pumping the water from below-ambient to atmospheric pressure or pressurizing the system with air to empty the water and then re-establishing the vacuum to reconnect with the dehumidifier. Using a membrane humidifier with an air-impermeable membrane allows the condensate water to stay at sub-ambient pressure on one side of the membrane and still drive evaporation into the air.

It would be impractical to operate this system when full of air that does not contribute to the thermodynamics while requiring energy to circulate, so the membrane humidifier and dehumidifier components use a material such as Aqualyte™, a styrenic block copolymer whose carefully controlled partial sulfonation results in hydrophilic regions within the solid polymer layer that allow rapid permeation of water molecules while restricting the movement of nitrogen, oxygen, and other components of air (see also U.S. Pat. Nos. 6,383,391, 6,413,298, and 7,179,860, all three of which are hereby incorporated herein by reference in their entireties). This allows an Aqualyte™ membrane surface to be exposed to an air stream without significantly compromising the integrity of a low-pressure region on the second side of the membrane. Evaporative cooling devices using this membrane were disclosed in U.S. U.S. Pat. No. 8,470,071, and membrane humidification and dehumidification systems were disclosed in the '518 patent. These devices transfer water molecules based on differences in vapor pressure while substantially blocking the movement of other components in the air stream.

Innovative Feature: Operation with Chilled Condenser Instead of Vapor Compressor

FIG. 7 shows the use of a vapor compressor to move vapor from the process air to a condenser where it can give up energy to the outside air and return the water to the chiller as condensate. The role played by the vapor compressor can instead be filled by any type of heat engine that is able to create a condensing surface behind the membrane as described above (with respect to Incorporating permeable membrane into condensing surfaces and vacuum insulating membrane surfaces from cooling surfaces) and move the heat to the outside air.

### Innovative Feature: Recovery of Heat to Drive Evaporative Cooling

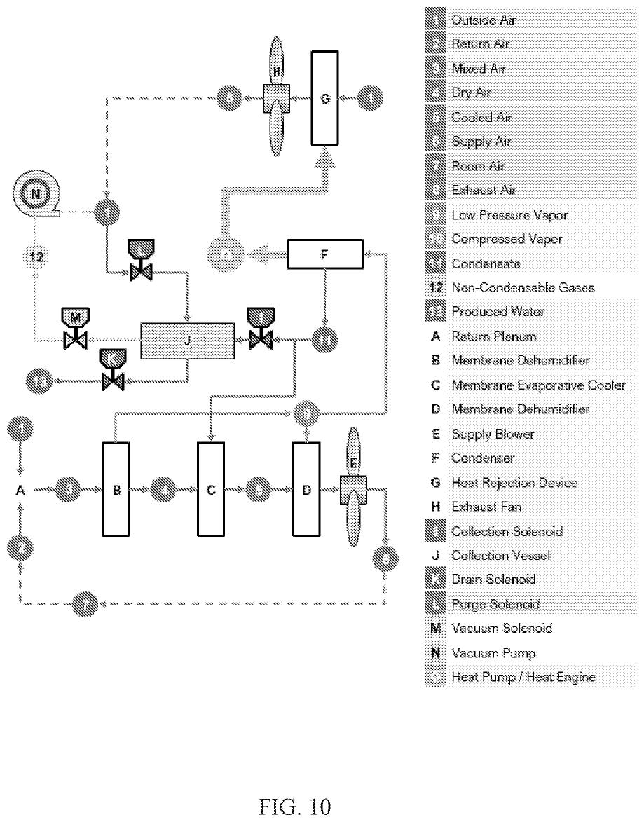

The liquid provided for the evaporative cooling process in FIG. 7 and FIG. 10 must have sufficient energy to drive evaporation. If the liquid temperature is below the dewpoint of the air passing on the other side of the membrane, the liquid will not evaporate. Multiple sources of heat can be used to adjust the temperature of this liquid as needed. For instance, the heat pump (O) or heat engine shown in FIG. 10 rejects much of its heat to the outside environment, but if there is a need for heat energy in the evaporation process a heat exchanger can be used to reject some of the heat into the evaporation process. Sources of waste heat elsewhere in the building can also be harvested as desired. Another source of heat that may prove useful is the process air on either side of the evaporative cooler; the liquid provided to the evaporative cooler can pass through a sensible heat exchanger on either side of the evaporative cooler to draw in heat that will drive evaporation.

### Innovative Feature: Maintain a Vacuum in Dehumidifiers and Other Components

The use of a highly selective Aqualyte™ membrane allows the system to maintain each of the major components at a low absolute pressure. Specifically, the evacuated space in the dehumidifiers should be at a pressure lower than the vapor pressure of the dehumidified process air to draw water vapor through the membrane. It is possible to configure the system so that vapor travels in a continuous evacuated plenum or connector to the remotely located condenser (see FIG. 10, item F), where it condenses and travels under the influence of gravity to fill the evaporative cooler without needing to be pumped to a higher pressure for any reason. A key to this design is forming the evaporative cooler with Aqualyte™ membrane as the interface between liquid and air, allowing evaporation despite a negative overall pressure gradient.

### Innovative Feature: Reduced Water Consumption in Dry Conditions

In dry conditions the process air to be conditioned may not have enough moisture for the initial membrane dehumidifier in FIG. 7 (item B) to pull water vapor out of the air, as the dehumidification action depends on the vapor pressure of the air being higher than the vapor pressure generated at the inlet to the vapor compressor. In this case the air would pass through membrane dehumidifier B without significant change and enter the membrane humidifier C at the same initial condition. It is also possible to eliminate dehumidifier B from the system entirely if convinced that there is little chance of needing to dehumidify the air before carrying out the evaporative cooling process.

This dry inlet condition is very suitable for evaporative cooling and many buildings in warm, dry climates have used evaporative cooling instead of vapor compression for energy efficient cooling. Beyond usability concerns with maintenance, health, and safety (all of which a membrane humidification component like the one shown in FIG. 7 improves measurably), there is an overriding concern with the consumption of water for cooling in dry climates. This limits the usage of evaporative cooling, which is generally a very energy efficient process.

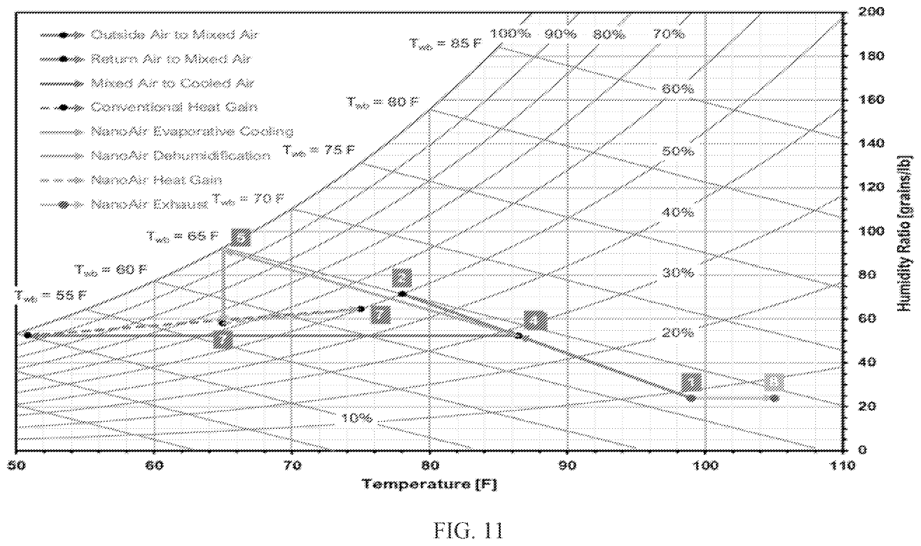

The operation of this innovative feature in dry weather is shown in FIG. 11. Using FIG. 7 as a reference for component labels again, dry air enters the membrane humidifier (C) in system and undergoes direct evaporative cooling before entering the second membrane dehumidifier (D), where humidity is removed across the selective membrane, compressed (F), and then condensed (G) to be returned as condensate that supplies makeup water to the membrane humidifier (C). According to the definition above of a dry climate as one where membrane dehumidifier B is unable to draw any humidity from the incoming air, it is known that membrane dehumidifiers B and D will not be able to dry the air sufficiently to remove every bit of the water vapor that was added as part of the evaporative cooling process in C. Instead, the exit condition from D will be chosen to ensure comfort among the inhabitants (it is expected that humidity would be in the range of 58-60 grains per pound (grains/lb) or about 58-about 60 grains/lb). This still represents significant dehumidification of the nearly saturated air exiting the membrane humidifier, and that water vapor will be condensed and returned to the evaporative cooler.

Depending on the air conditions entering the system, 80%-90% (or about 80% to about 90%) of the water used to cool the air can be captured and returned to cool again even when the entering conditions are too dry to generate excess water as described above (with respect to reversing the flow of vapor to humidify the process fluid). The difference in water supply would have to be supplied as makeup to the system, but this still means the system uses much, much less water than traditional swamp cooling does. A further advantage of membrane evaporative cooling is that it is more tolerant of poor water quality than traditional evaporative systems (the controlled, non-fouling interface eliminates local concentrations to keep dissolved solids in solution), expanding options for water sources so that wastewater and saline water can be used to cool the air.

Innovative Feature: Minimizing Sensible Heat Gain with Desiccant Solutions

Absorption systems can use desiccant solutions (brines and ionic liquids are commonly chosen) to pull water vapor from a process air stream, but one of the common hurdles they face is that the isentropic process releases sensible heat as the moisture is adsorbed or absorbed into the desiccant solution. Higher sensible temperatures reduce the dehumidification ability of the desiccant solution, so systems typically place a coolant in contact with the desiccant solution to reduce its temperature. The ability to keep the solution cool is further compromised by the sensible heat transfer taking place between the desiccant and the process air. In many cases, the air has a higher dry bulb temperature than the desired solution temperature, and bringing a high surface area of solution in contact with the process air increases the difficulty in maintaining desiccant conditions.

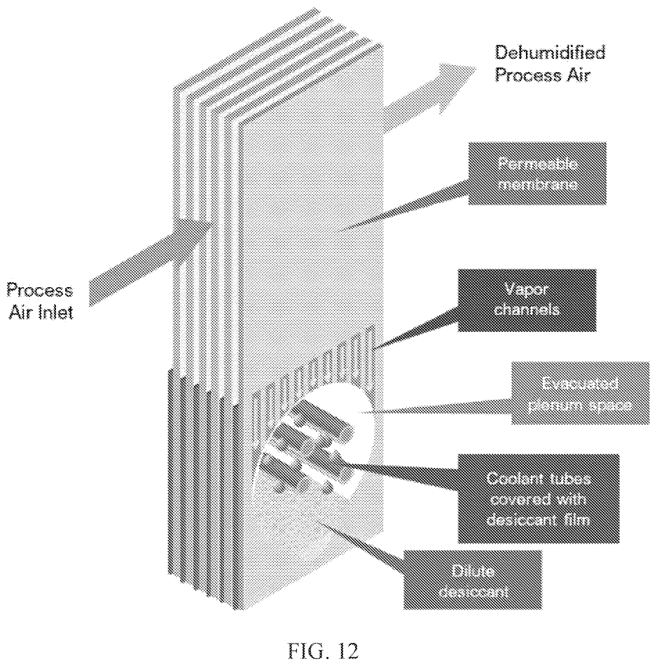

It is possible to customize the system outlined in FIG. 2 and incorporate a liquid desiccant solution in a way that eliminates that sensible heat transfer with the process air. The liquid desiccant establishes a low vapor pressure inside the evacuated plenum and still communicates heat to the cooling tubes, but it no longer heats the process air significantly. With this innovation, a high surface area of desiccant solution can be provided without increasing the heat transfer between solution and process air. FIG. 12 shows a cross-sectional view of a system according to an embodiment of the subject invention, embodying this design where the desiccant solution is applied to cooling tubes as a falling film for a high surface area that absorbs water vapor from the evacuated plenum without having substantial contact with the process air on the far side of the selective membrane. The heat of condensation released as the vapor is absorbed into the desiccant can be removed by the cooling tubes without having to compete with additional heat absorbed from the process air.

### Innovative Feature: Use for Distillation Processes

The architecture of embodiments of the subject invention can be used for a distillation process where the goal is isolation of a clean condensate that has traveled through the selective membrane. A distillation device can be used to generate clean water from a compromised source or to reduce the concentration of a solution so that it can be regenerated and/or concentrated as desired.

When ranges are used herein, such as for weight ranges, combinations and subcombinations of ranges (e.g., subranges within the disclosed range), specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 foot” means from 0.95 foot to 1.05 foot.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

1. A system for changing a humidity level of a process air, the system comprising:
a permeable membrane having a first surface and a second surface opposite from the first surface, wherein the second surface is configured to be in direct physical contact with the process air as the process air travels through the system;
a condenser comprising a nonpermeable material and having a first surface facing the permeable membrane; and
an evacuated volume between the first surface of the condenser and the first surface of the permeable membrane.

2. The system according to claim 1, wherein the first surface of the condenser and the evacuated volume are disposed in a portion of the system that is vacuum sealed from an outside and only allows fluid to enter or exit via the permeable membrane,
wherein the condenser comprises cooling tubes configured to have chilled fluid passed therethrough to thereby cool the evacuated volume, wherein the cooling tubes comprise the nonpermeable material,
wherein the permeable membrane comprises vapor channels configured to have vapor molecules of the process air flow therethrough and into the evacuated volume, and
wherein the permeable membrane is selectively permeable such that it allows water and water vapor, but not other entities, to pass therethrough.

3-4. (canceled)

5. The system according to claim 1, wherein the permeable membrane comprises a styrenic block copolymer with partial sulfonation, wherein the styrenic block copolymer comprises hydrophilic regions within a solid polymer layer thereof.

6. The system according to claim 1, further comprising a chilled liquid in direct physical contact with the first surface of the permeable membrane, wherein the chilled liquid has a temperature lower than a dewpoint of the process air.

7. The system according to claim 1, wherein the system is configured to switch between a dehumidification mode configured to decrease the humidity level of the process air and a humidification mode configured to increase the humidity level of the process air.

8. The system according to claim 1, wherein the system is configured such that the condenser can be switched to operate such that vapor is generated in the evacuated volume at a vapor pressure higher than that of the process air, thereby resulting in humidification of the process air as the process air travels through the system.

9. The system according to claim 1, further comprising a storage chamber configured to collect condensation that forms on the first surface of the condenser,
wherein the system is configured such that condensation in the storage chamber is provided to the first surface of the condenser in a humidification mode of the system.

10. (canceled)

11. The system according to claim 1, wherein the system is configured to cool the process air before the humidity level of the process air is decreased.

12. The system according to claim 1, wherein the system is configured such that condensation occurs within the system before the humidity level of the process air is decreased.

13. The system according to claim 1, wherein the permeable membrane is a first stage of dehumidification for the process air,
wherein the system comprises a second stage of dehumidification for the process air after the process air exits the first stage of dehumidification, and
wherein the system is configured to perform at least one of the following:
collect condensation from the first stage of dehumidification and the second stage of dehumidification in a single common collector; and
provide condensation from the first stage of dehumidification and the second stage of dehumidification to a separate humidifier in operable communication with the system.

14-15. (canceled)

16. The system according to claim 1, wherein a pressure of the evacuated volume during operation is lower than a vapor pressure of the process air when the system operates in a dehumidification mode.

17. The system according to claim 1, wherein the system is configured to collect condensation that forms on the first surface of the condenser and use the condensation as a fluid within the condenser.

18. The system according to claim 1, further comprising a film of a desiccant solution disposed on the first surface of the condenser,
wherein the first surface of the condenser is completely covered with the film of the desiccant solution.

19. (canceled)

20. A method for changing a humidity level of a process air, the method comprising:
providing the system according to claim 1;
sending the process air having a first humidity level into an inlet of the system while operating the condenser of the system; and
allowing the process air to exit an outlet of the system with second humidify level different from the first humidity level.

21. The method according to claim 20, further comprising providing a chilled liquid in direct physical contact with the first surface of the permeable membrane while the process air is in the system, wherein the chilled liquid has a temperature lower than a dewpoint of the process air.

22. The method according to claim 20, wherein the condenser is operated such that vapor is generated in the evacuated volume at a vapor pressure higher than that of the process air, thereby resulting in humidification of the process air as the process air travels through the system.

23. The method according to claim 20, further comprising:
collecting condensation that forms on the first surface of the condenser in a dehumidification mode of the system; and
providing the collected condensation to the first surface of the condenser in a humidification mode of the system.

24. The method according to claim 20, further comprising cooling the process air before the humidity level of the process air is decreased,
wherein conde tion occurs within the system before the humidity level of the process air is decreased.

25. (canceled)

26. The method according to claim 20, further comprising providing any condensation collected within the system to a separate humidifier in operable communication with the system.

27. The method according to claim 20, wherein the condenser is operated such that a pressure of the evacuated volume is lower than a vapor pressure of the process air, thereby resulting in dehumidification of the process air as the process air travels through the system.

28. (canceled)
